(19) United States
(12) Patent Application Publication
(10) Pub. No.: US 2023/0117626 A1
(43) Pub. Date: Apr. 20, 2023

(54) CONVOLUTION APPARATUS, CONVOLUTION METHOD, MATRIX UNKNIT-KNIT DEVICE AND MATRIX UNKNIT-KNIT METHOD

(71) Applicant: Shanghai Biren Technology Co.,Ltd, Shanghai (CN)

(72) Inventors: Hao SHU, Shanghai (CN); Zhou HONG, Shanghai (CN); Lin CHEN, Shanghai (CN); Tong SUN, Shanghai (CN); Zhu LIANG, Shanghai (CN); ChengKun SUN, Shanghai (CN)

(73) Assignee: Shanghai Biren Technology Co.,Ltd, Shanghai (CN)

(21) Appl. No.: 17/958,441

(22) Filed: Oct. 3, 2022

(30) Foreign Application Priority Data
Oct. 14, 2021 (CN) 202111195064.8

(51) Int. Cl. G06F 17/15

(52) U.S. Cl. CPC G06F 17/153

(57) ABSTRACT

A convolution apparatus including a data memory, a matrix unknit-knit device, and a convolution operation device, a convolution method, a matrix unknit-knit device, and a matrix unknit-knit method are provided. The matrix unknit-knit device unknits a first matrix stored in the data memory into s*s second matrices (or knits the s*s second matrices into the first matrix), where s is greater than 1. Pixels in each of s*s subblocks in the first matrix serve one-to-one as pixels of the s*s second matrices. A convolution operation device unknits a convolution kernel of a convolution operation with a stride of s into s*s sub-kernels, uses any one of the sub-kernels to perform a convolution operation with a stride of 1 on one corresponding second matrix, and accumulates the operation results the second matrices as the operation result of performing the convolution operation with a stride of s on the first matrix.

### CROSS-REFERENCE TO RELATED APPLICATION

This application claims the priority benefit of China application serial no. 202111195064.8, filed on Oct. 14, 2021. The entirety of the above-mentioned patent application is hereby incorporated by reference herein and made a part of this specification.

### BACKGROUND

### Technical Field

The disclosure relates to a matrix operation, and in particular, relates to a convolution apparatus, a convolution method, a matrix unknit-knit device, and a matrix unknit-knit method.

### Description of Related Art

In artificial intelligence (AI) or neural networks, a large number of matrix multiplication operations are often performed. As an example, natural language processing (NLP) models have a large number of general matrix multiplication (GEMM) operations. Based on GEMM, there are also a large number of convolution operations in the computer vision (CV) models. Based on practical applications, the processing unit may use a convolution kernel to perform a convolution operation on the target matrix with a stride of 1, 2, or other values. The convolution operation with a stride of 1 is a well-known operation, so description thereof is not provided herein. After completing the convolution operation with a stride 1 on the m*n target matrix, the processing unit may generate another m*n matrix to serve as the result of the convolution operation.

After completing the convolution operation with a stride of 2 on the m*n target matrix, the processing unit can generate a (m/2)*(n/2) matrix to serve as the result of the convolution operation. For a convolution operation with a stride of 2, the known processing unit first performs a convolution operation with a stride of 1 on an m*n target matrix to generate an m*n operation result matrix and then discards ¾ of the pixels in the result matrix to produce a (m/2)*(n/2) matrix of as the result of the convolution operation with a stride of 2. It is conceivable that the generation of each of the m*n pixels of the operation result matrix requires computing power and time. Discarding pixels means wasting computing power and time. How to more efficiently perform a convolution operation with a stride greater than 1 on a matrix is one of the important technical issues in this technical field.

### SUMMARY

The disclosure provides a convolution apparatus, a convolution method, a matrix unknit-knit device, and a matrix unknit-knit method to efficiently perform a convolution operation with a stride greater than 1 on a matrix.

In an embodiment according to the disclosure, the convolution apparatus is configured to perform a convolution operation with a stride greater than 1. The convolution apparatus includes a data memory, a matrix unknit-knit device, and a convolution operation device. The matrix unknit-knit device is coupled to the data memory. The matrix unknit-knit device is configured to unknit a first matrix stored in the data memory into s*s second matrices or knits the s*s second matrices stored in the data memory into the first matrix, where the s is an integer greater than 1 and is the stride of the convolution operation. The first matrix is split into a plurality of s*s subblocks. s*s pixels in each of these s*s subblocks serve one-to-one as one pixel of the s*s second matrices. The convolution operation device is coupled to the data memory. The convolution operation device unknits a convolution kernel used for performing the convolution operation with a stride of s on the first matrix into s*s sub-kernels according to the s*s pixels, where the s*s sub-kernels are applied one-to-one to the s*s second matrices. The convolution operation device uses any one of the s*s sub-kernels to perform a convolution operation with a stride of 1 on one corresponding second matrix among the s*s second matrices to generate a first operation result. The convolution operation device accumulates the first operation result of each of the s*s second matrices as a second operation result of performing the convolution operation with the stride of s on the first matrix.

In the embodiments of the disclosure, a convolution method is configured to perform a convolution operation with a stride greater than 1. The convolution method includes the following steps. A matrix unknit-knit device unknits a first matrix stored in a data memory into s*s second matrices or knits the s*s second matrices stored in the data memory into the first matrix, where the s is an integer greater than 1 and is the stride of the convolution operation. The first matrix is split into a plurality of s*s subblocks. s*s pixels in each of the plurality of s*s subblocks serve one-to-one as one pixel of the s*s second matrices. A convolution operation device unknits a convolution kernel used for performing the convolution operation with a stride of s on the first matrix into s*s sub-kernels according to the s*s pixels. The s*s sub-kernels are applied one-to-one to the s*s second matrices. The convolution operation device uses any one of the s*s sub-kernels to perform a convolution operation with a stride of 1 on one corresponding second matrix among the s*s second matrices to generate a first operation result. The convolution operation device accumulates the first operation result of each of the s*s second matrices as a second operation result of performing the convolution operation with the stride of s on the first matrix.

In the embodiments of the disclosure, the matrix unknit-knit device includes a temporary register and an execution unit. The temporary register is configured to read a first matrix or s*s second matrices from the data memory. The execution unit is coupled to the temporary register. The execution unit is configured to unknit the first matrix stored in the temporary register into the s*s second matrices or knit the s*s second matrices stored in the temporary register into the first matrix, where the s is an integer greater than 1. The first matrix is split into a plurality of s*s subblocks. s*s pixels in each of the plurality of s*s subblocks serve one-to-one as one pixel of the s*s second matrices.

In the embodiments of the disclosure, the matrix unknit-knit method includes the following steps. The temporary register reads a first matrix or s*s second matrices from a data memory. The execution unit unknits the first matrix stored in the temporary register into the s*s second matrices or knits the s*s second matrices stored in the temporary register into the first matrix, where the s is an integer greater than 1. The first matrix is split into a plurality of s*s subblocks. s*s pixels in each of the plurality of s*s subblocks serve one-to-one as one pixel of the s*s second matrices.

To sum up, in the embodiments of the disclosure, the convolution apparatus first uses the matrix unknit-knit device to unknit and knit a matrix. For instance, the matrix unknit-knit device can unknit the first matrix into s*s second matrices. Alternatively, the matrix unknit-knit device can knit s*s second matrices into the first matrix, where the s is the stride of the convolution operation and is an integer greater than 1. In addition, convolution operation device can unknit the convolution kernel of the convolution operation into s*s sub-kernels according to the s*s pixels. Herein, these sub-kernels are applied one-to-one to these second matrices. Based on the unknitting of the first matrix and the convolution kernel, the convolution operation device can use any sub-kernel to perform a convolution operation with a stride of 1 on a corresponding second matrix. The convolution operation device can accumulate the operation result of each of the second matrices as the operation result of performing the convolution operation with a stride of s on the first matrix. Therefore, in the convolution apparatus, a convolution operation with a stride greater than 1 can be efficiently performed on the matrix.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of a convolution apparatus according to an embodiment of the disclosure.

FIG. 2 is a schematic flow chart of a convolution method according to an embodiment of the disclosure.

FIG. 3 is a schematic diagram illustrating a specific example of an 8*8 matrix according to an embodiment of the disclosure.

FIG. 4 is a schematic diagram illustrating a specific example in which the 8*8 matrix shown in FIG. 3 is unknitted into four second matrices according to an embodiment of the disclosure.

FIG. 5 is a schematic diagram illustrating a specific example of a 3*3 matrix according to an embodiment of the disclosure.

FIG. 6 is a schematic diagram illustrating a specific example in which the 3*3 matrix shown in FIG. 5 is unknitted into 4 sub-kernels according to an embodiment of the disclosure.

FIG. 7 is a schematic diagram illustrating a specific example of a 9*9 matrix according to another embodiment of the disclosure.

FIG. 8 is a schematic diagram illustrating a specific example in which the 9*9 matrix shown in FIG. 7 is unknitted into 9 second matrices according to an embodiment of the disclosure.

FIG. 9 is a schematic circuit block diagram illustrating a matrix unknit-knit device shown in FIG. 1 according to an embodiment of the disclosure.

FIG. 10 is a schematic flow chart of a matrix unknit-knit method according to an embodiment of the disclosure.

FIG. 11 is a schematic flow chart of a matrix unknit-knit method according to another embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

The term “coupled to (or connected to)” used in the entire specification (including claims) refers to any direct or indirect connecting means. For instance, if the disclosure describes a first apparatus is coupled to (or connected to) a second apparatus, the description should be explained as the first apparatus is connected directly to the second apparatus, or the first apparatus, through connecting other apparatus or using certain connecting means, is connected indirectly to the second apparatus. In addition, terms such as “first” and “second” in the entire specification (including claims) are used only to name the elements and should not be construed as the upper limit or lower limit of the number of any element and should not be construed to limit the order of the elements. Moreover, components/members/steps with the same reference numerals represent the same or similar parts in the accompanying figures and embodiments where appropriate. Elements/components/steps having same reference numerals or same terms are used as cross reference in different embodiments.

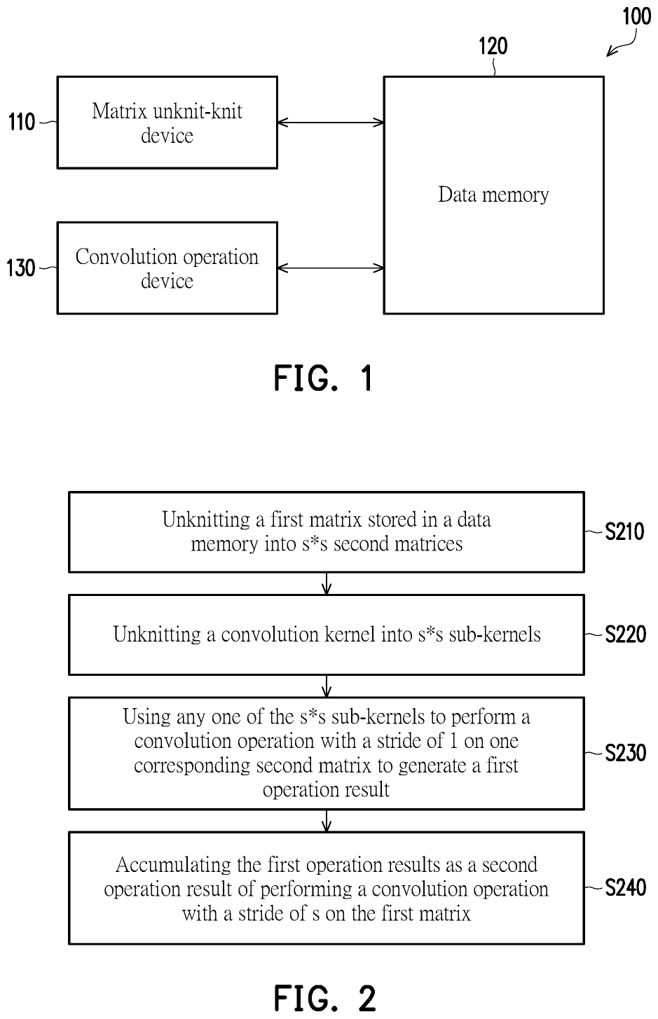

FIG. 1 is a schematic circuit block diagram of a convolution apparatus 100 according to an embodiment of the disclosure. The convolution apparatus 100 shown in FIG. 1 includes a matrix unknit-knit device 110, a data memory 120, and a convolution operation device 130. The matrix unknit-knit device 110 is coupled to the data memory 120. The matrix unknit-knit device 110 can unknit a first matrix stored in the data memory 120 into s*s second matrices. Alternatively, the matrix unknit-knit device 110 can knit the s*s second matrices stored in the data memory 120 into the first matrix. Herein, the s is an integer greater than 1, and s is the stride of the convolution operation performed by the convolution operation device 130. The stride s of the convolution operation can be determined according to the actual design.

FIG. 2 is a schematic flow chart of a convolution method according to an embodiment of the disclosure. With reference to FIG. 1 and FIG. 2, in step S210, the matrix unknit-knit device 110 can unknit a first matrix stored in the data memory 120 into s*s second matrices (or can knit the s*s second matrices stored in the data memory 120 into the first matrix). Herein, the first matrix is split into a plurality of s*s subblocks. The abovementioned s*s subblocks means an s*s sub-matrix, that is, a subblock has s*s pixels. The s*s pixels in each of these s*s subblocks serve one-to-one as one pixel of these second matrices. For instance, the matrix unknit-knit device 110 may read the first matrix from the data memory 120. The matrix unknit-knit device 110 can split the first matrix into a plurality of s*s subblocks. The matrix unknit-knit device 110 may collect pixels at a same position in these s*s subblocks as s*s pixels of one of these second matrices. Therefore, the matrix unknit-knit device 110 can unknit one first matrix into s*s second matrices. The matrix unknit-knit device 110 may collect pixels at the same position in these s*s subblocks as s*s pixels of one second matrix. Therefore, the matrix unknit-knit device 110 can unknit one first matrix into s*s second matrices.

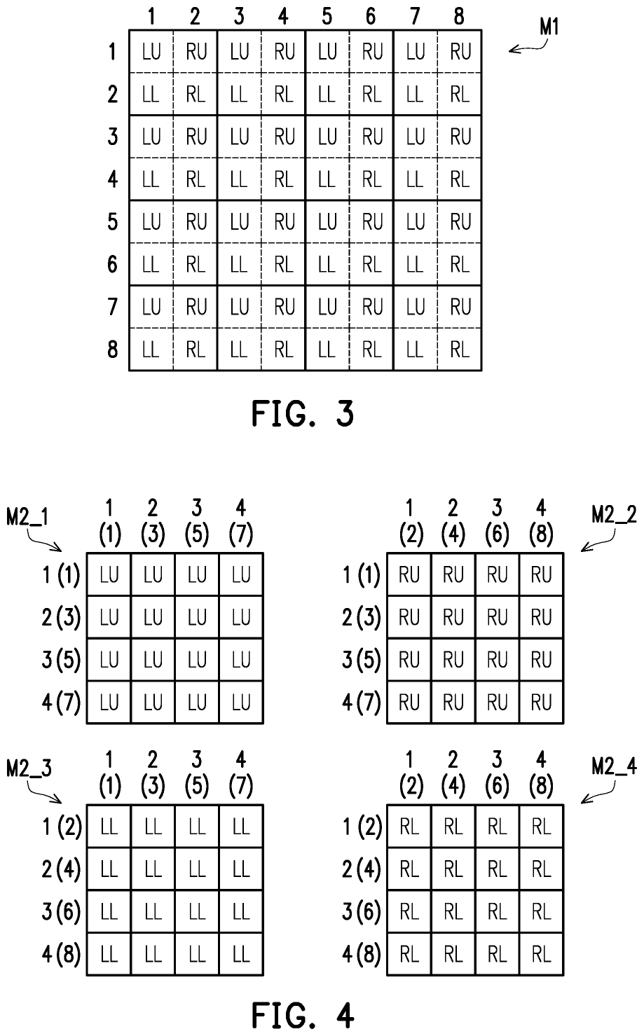

As an example, the strides of the convolution operation may be 2. FIG. 3 is a schematic diagram illustrating a specific example of an 8*8 matrix according to an embodiment of the disclosure. The 8*8 matrix shown in FIG. 3 may be used as a first matrix M1. The horizontal axis shown in FIG. 3 indicates column numbers 1 to 8 of the first matrix M1, and the vertical axis shown in FIG. 3 indicates row numbers 1 to 8 of the first matrix M1. The matrix unknit-knit device 110 may read the first matrix M1 from the data memory 120. Since the stride s of the convolution operation is 2, the matrix unknit-knit device 110 may split the first matrix M1 into a plurality of 2*2 subblocks (i.e., the multiple solid-line boxes shown in FIG. 3). The same position in these 2*2 subblocks is marked with the same reference sign, and different positions in a subblock are marked with different reference signs. In the embodiment shown in FIG. 3, the 2*2 pixels in each of these subblocks (i.e., the solid-line boxes shown in FIG. 3) include an upper left pixel LU, an upper right pixel RU, a lower left pixel LL, and a lower right pixel RL. It should be noted that the pixels marked with the same reference sign (e.g., LU) do not represent the same (or different) values. The reference signs LU, RU, LL, and RL are independent of pixel values. The matrix unknit-knit device 110 may collect pixels at the same position in these 2*2 subblocks as pixels of one second matrix. Therefore, the first matrix M1 can be unknitted into 2*2 second matrices.

FIG. 4 is a schematic diagram illustrating a specific example in which the 8*8 matrix shown in FIG. 3 is unknitted into 4 second matrices according to an embodiment of the disclosure. The 4 second matrices shown in FIG. 4 are an unknitted matrix M2_1, an unknitted matrix M2_2, an unknitted matrix M2_3, and an unknitted matrix M2_4. These unknitted matrices M2_1 to M2_4 are all 4*4 matrices. The matrix unknit-knit device 110 may collect the upper left pixels LU at the same position in these 2*2 subblocks of the first matrix M1 as the pixels of the unknitted matrix M2_1 (the second matrix). The horizontal axis shown in FIG. 4 indicates the column numbers 1 to 4 of the unknitted matrix M2_1, where the column numbers in the parentheses represent the column numbers of the first matrix M1 shown in FIG. 3. The vertical axis shown in FIG. 4 indicates the row numbers 1 to 4 of the unknitted matrix M2_1, where the row numbers in the parentheses represent the row numbers of the first matrix M1 shown in FIG. 3. Description of the unknitted matrix M2_2, the unknitted matrix M2_3, and the unknitted matrix M2_4 may be deduced by referring to the relevant description of the unknitted matrix M2_1, so repeated description is not provided herein.

With reference to FIG. 1 and FIG. 2, in step S220, the convolution operation device 130 shown in FIG. 1 is coupled to the data memory 120. The convolution operation device 130 can unknit a convolution kernel used for performing the convolution operation with a stride of s on the first matrix into s*s sub-kernels according to the s*s pixels. Herein, these sub-kernels are applied one-to-one to the s*s second matrices. The convolution kernel can be a matrix. The number of columns and rows of the convolution kernel can be determined according to the actual design.

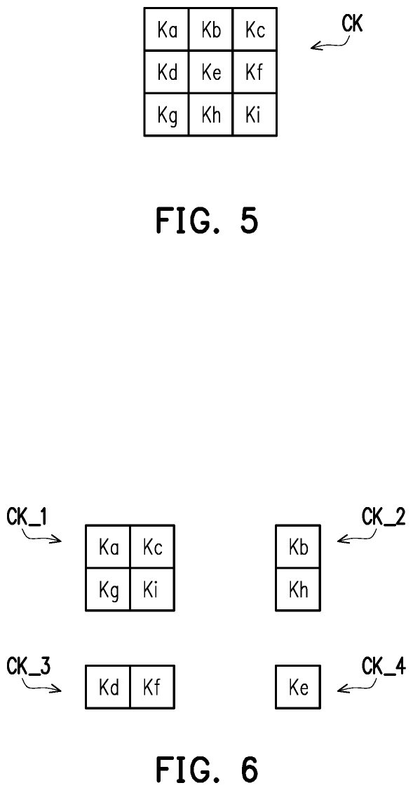

As an example, the stride s of the convolution operation may be 2, and the convolution kernel may be a 3*3 matrix. FIG. 5 is a schematic diagram illustrating a specific example of a 3*3 matrix according to an embodiment of the disclosure. The 3*3 matrix shown in FIG. 3 may be used as a convolution kernel CK. The convolution kernel CK has pixels Ka, Kb, Kc, Kd, Ke, Kf, Kg, Kh, and Ki. The values of these pixels Ka to Ki of the convolution kernel may be determined according to the actual design. The convolution operation device 130 can unknit the convolution kernel CK used for performing the convolution operation with a stride of 2 on the first matrix M1 into 2*2 sub-kernels.

FIG. 6 is a schematic diagram illustrating a specific example in which the 3*3 matrix shown in FIG. 5 is unknitted into 4 sub-kernels according to an embodiment of the disclosure. When the stride s of the convolution operation is 2, the convolution kernel CK shown in FIG. 5 can be divided into 4 sub-kernels shown in FIG. 6, namely, a sub-kernel CK_1, a sub-kernel CK_2, a sub-kernel CK_3, and a sub-kernel CK_4. The sub-kernel CK_1 is a 2*2 matrix and includes the upper left pixel Ka, the upper right pixel Kc, the lower left pixel Kg, and the lower right pixel Ki of the convolution kernel CK. The sub-kernel CK_2 is a 2*1 matrix and includes the upper middle pixel Kb and the lower middle pixel Kh of the convolution kernel CK. The sub-kernel CK_3 is a 1*2 matrix and includes the middle left pixel Kd and the middle right pixel Kf of the convolution kernel CK. The sub-kernel CK_4 is a 1*1 matrix and includes the middle middle pixel Ke of the convolution kernel CK.

With reference to FIG. 1 and FIG. 2, In step S230, the convolution operation device 130 may use any one of the s*s sub-kernels to perform a convolution operation with a stride of 1 on one corresponding second matrix among the s*s second matrices to generate a first operation result. The convolution operation process with a stride of 1 is a well-known operation, so description thereof is not provided herein. In step S240, the convolution operation device 130 can accumulate the first operation result of each of the s*s second matrices and treats the accumulated result as an operation result (second operation result) of performing the convolution operation with a stride of s on the first matrix.

As an example, the stride s of the convolution operation performed on the first matrix M1 shown in FIG. 3 may be 2, and the convolution kernel may be a 3*3 matrix. With reference to FIG. 3 to FIG. 6, the convolution operation device 130 may use the sub-kernel CK_1 shown in FIG. 6 to perform a convolution operation with a stride of 1 on the unknitted matrix M2_1 (corresponding to the second matrix) shown in FIG. 4 to generate a 4*4 matrix (the first operation result of the unknitted matrix M2_1). The convolution operation process with a stride of 1 is a well-known operation, so description thereof is not provided herein. The convolution operation device 130 may use the sub-kernel CK_2 shown in FIG. 6 to perform a convolution operation with a stride of 1 on the unknitted matrix M2_2 (corresponding to the second matrix) shown in FIG. 4 to generate another 4*4 matrix (the first operation result of the unknitted matrix M2_2). The convolution operation device 130 may use the sub-kernel CK_3 shown in FIG. 6 to perform a convolution operation with a stride of 1 on the unknitted matrix M2_3 (corresponding to the second matrix) shown in FIG. 4 to generate yet another 4*4 matrix (the first operation result of the unknitted matrix M2_3). The convolution operation device 130 may use the sub-kernel CK_4 shown in FIG. 6 to perform a convolution operation with a stride of 1 on the unknitted matrix M2_4 (corresponding to the second matrix) shown in FIG. 4 to generate still another 4*4 matrix (the first operation result of the unknitted matrix M2_4). The convolution operation device 130 may accumulate the first operation results of the unknitted matrices M2_1 to M2_4 to generate a 4*4 matrix (accumulation result). The convolution operation device 130 may treat the accumulation result as the operation result of the convolution operation with a stride of 2 performed on the first matrix M1 shown in FIG. 3 using the convolution kernel CK shown in FIG. 5.

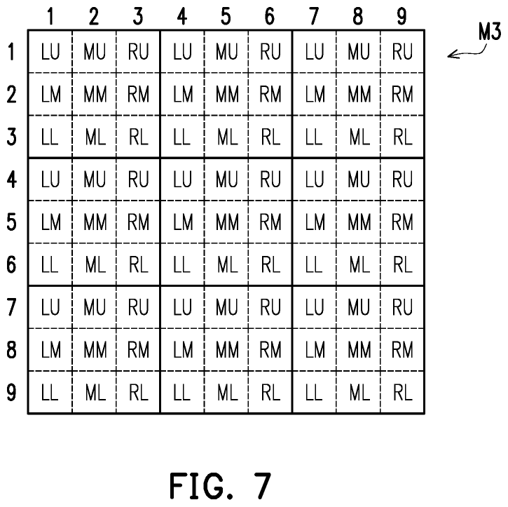

It should be emphasized that, according to the actual design, the stride s of the convolution operation can be greater than 2. As an example, the stride s of the convolution operation may be 3. FIG. 7 is a schematic diagram illustrating a specific example of a 9*9 matrix according to another embodiment of the disclosure. The 9*9 matrix shown in FIG. 7 may be used as a first matrix M3. The horizontal axis shown in FIG. 7 indicates column numbers 1 to 9 of the first matrix M3, and the vertical axis shown in FIG. 7 indicates row numbers 1 to 9 of the first matrix M3. The matrix unknit-knit device 110 may read the first matrix M3 from the data memory 120. Since the stride s of the convolution operation is 3, the matrix unknit-knit device 110 may split the first matrix M3 into a plurality of 3*3 subblocks (i.e., the multiple solid-line boxes shown in FIG. 7). The same position in these 3*3 subblocks is marked with the same reference sign, and different positions in a subblock are marked with different reference signs. In the embodiment shown in FIG. 7, the 3*3 pixels in each of these subblocks (i.e., the solid-line boxes shown in FIG. 7) include an upper left pixel LU, an upper middle pixel MU, an upper right pixel RU, a middle left pixel LM, a middle middle pixel MM, a middle right pixel RM, a lower left pixel LL, a lower middle pixel ML, and a lower right pixel RL. It should be noted that the pixels marked with the same reference sign (e.g., LU) do not represent the same (or different) values. The reference signs LU, MU, RU, LM, MM, RM, LL, ML, and RL are independent of pixel values. The matrix unknit-knit device 110 may collect pixels at the same position in these 3*3 subblocks as pixels of one second matrix. Therefore, the first matrix M3 can be unknitted into 3*3 second matrices.

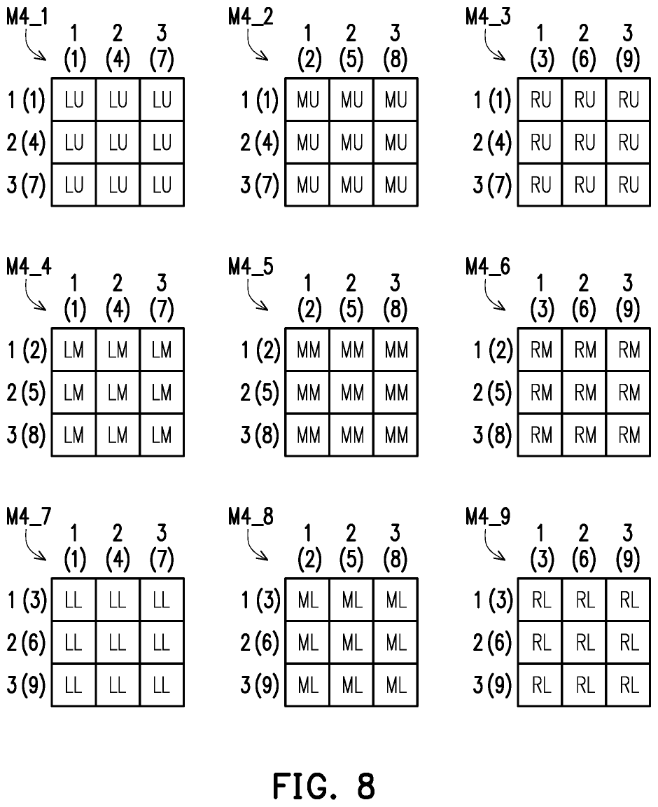

FIG. 8 is a schematic diagram illustrating a specific example in which the 9*9 matrix shown in FIG. 7 is unknitted into 9 second matrices according to an embodiment of the disclosure. The 9 second matrices shown in FIG. 8 are an unknitted matrix M4_1, an unknitted matrix M4_2, an unknitted matrix M4_3, an unknitted matrix M4_4, an unknitted matrix M4_5, an unknitted matrix M4_6, an unknitted matrix M4_7, an unknitted matrix M4_8, and an unknitted matrix M4_9. These unknitted matrices M4_1 to M4_9 are all 3*3 matrices. The matrix unknit-knit device 110 may collect the upper left pixels LU at the same position in these 3*3 subblocks of the first matrix M3 as the pixels of the unknitted matrix M4_1 (the second matrix). The horizontal axis shown in FIG. 8 indicates the column numbers 1 to 3 of the unknitted matrix M4_1, where the column numbers in the parentheses represent the column numbers of the first matrix M3 shown in FIG. 7. The vertical axis shown in FIG. 8 indicates the row numbers 1 to 3 of the unknitted matrix M4_1, where the row numbers in the parentheses represent the row numbers of the first matrix M3 shown in FIG. 7. Description of the unknitted matrix M4_2, the unknitted matrix M4_3, the unknitted matrix M4_4, the unknitted matrix M4_5, the unknitted matrix M4_6, the unknitted matrix M4_7, the unknitted matrix M4_8, and the unknitted matrix M4_9 may be deduced by referring to the relevant description of the unknitted matrix M4_1, so repeated description is not provided herein.

FIG. 3 and FIG. 4 illustrate one example of a matrix unknitting operation, and FIG. 7 and FIG. 8 illustrate another example of the matrix unknitting operation. Corresponding to the matrix unknitting operation of the matrix unknit-knit device 110, the convolution operation device 130 may unknit the convolution kernel CK of the convolution operation into s*s sub-kernels, where these sub-kernels are applied to different unknitted matrix (second matrices) one-to-one. Based on the unknitting of the first matrix and the convolution kernel CK, the convolution operation device may use any sub-kernel to perform a convolution operation with a stride of 1 on a corresponding second matrix. The convolution operation device may accumulate the operation results of the second matrices as the operation result of performing the convolution operation with a stride of s on the first matrix using the convolution kernel CK. Therefore, in the convolution apparatus, a convolution operation with a stride greater than 1 can be efficiently performed on the matrix. It can be inferred from the related description of the above embodiments that the matrix unknit-knit device 110 may knit the s*s second matrices stored in the data memory 120 into the first matrix. For instance, the matrix unknit-knit device 110 may read the s*s second matrices from the data memory 120. The matrix unknit-knit device 110 can split the first matrix into a plurality of s*s subblocks. The matrix unknit-knit device 110 may collect the pixels at the same position in the s*s second matrices as the pixels of one of these s*s subblocks of the first matrix to knit these second matrices into the first matrix.

FIG. 9 is a schematic circuit block diagram illustrating the matrix unknit-knit device 110 shown in FIG. 1 according to an embodiment of the disclosure. The matrix unknit-knit device 110 shown in FIG. 1 includes a temporary register 111 and an execution unit 112. The temporary register 111 may read the first matrix (e.g., the first matrix M1 shown in FIG. 3 or the first matrix M3 shown in FIG. 7) or s*s second matrices (e.g., the second matrices M2_1 to M2_4 shown in FIG. 4 or the second matrices M4_1 to M4_9 shown in FIG. 8) from the data memory 120. The execution unit 112 may execute an instruction CMD. Based on the execution of the instruction CMD, the execution unit 112 may unknit the first matrix stored in the temporary register 111 into the s*s second matrices or knit the s*s second matrices stored in the temporary register 111 into the first matrix, where the s is an integer greater than 1. In other embodiments, the execution unit 112 may, through other control methods, unknit the first matrix stored in the temporary register 111 into the s*s second matrices or knit the s*s second matrices stored in the temporary register 111 into the first matrix,

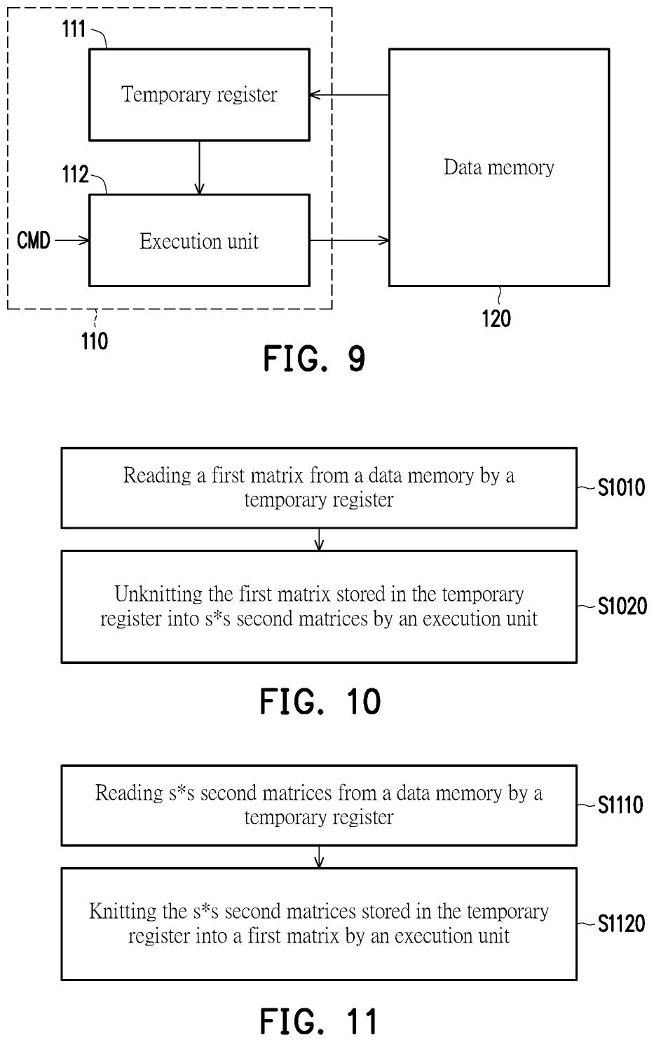

FIG. 10 is a schematic flow chart of a matrix unknit-knit method according to an embodiment of the disclosure. With reference to FIG. 9 and FIG. 10, in step S1010, the temporary register 111 may read the first matrix (e.g., the first matrix M1 shown in FIG. 3 or the first matrix M3 shown in FIG. 7) from the data memory 120. In step S1020, the execution unit 112 may execute the instruction CMD to unknit the first matrix stored in the temporary register 111 into s*s second matrices (e.g., the second matrices M2_1 to M2_4 shown in FIG. 4 or the second matrices M4_1 to M4_9 shown in FIG. 8). For instance, the execution unit 112 may read the first matrix M1 from the temporary register 111 and then split the first matrix M1 into a plurality of s*s subblocks (e.g., the plurality of 2*2 subblocks shown in FIG. 3, i.e., the plurality of solid-line boxes shown in FIG. 3). The execution unit 112 may collect the pixels at the same position in these 2*2 subblocks as the pixels of one of the second matrices M2_1 to M2_4 shown in FIG. 4. For instance, the execution unit 112 may collect the upper left pixels LU at the same position in these 2*2 subblocks of the first matrix M1 as the pixels of the unknitted matrix M2_1 (the second matrix). Therefore, the execution unit 112 may unknit the first matrix M1 into the second matrices M2_1 to M2_4. Similar to the description provided for FIG. 3 and FIG. 4, the temporary register 111 and the execution unit 112 may also unknit the first matrix M3 shown in FIG. 7 into the second matrices M4_1 to M4_9 shown in FIG. 8.

FIG. 11 is a schematic flow chart of a matrix unknit-knit method according to another embodiment of the disclosure. With reference to FIG. 9 and FIG. 11, in step S1110, the temporary register 11I may read s*s second matrices (e.g., the second matrices M2_1 to M2_4 shown in FIG. 4 or the second matrices M4_1 to M4_9 shown in FIG. 8) from the data memory 120. In step S1120, the execution unit 112 may execute the instruction CMD to knit the s*s second matrices stored in the temporary register 111 into the first matrix (e.g., the first matrix M1 shown in FIG. 3 or the first matrix M3 shown in FIG. 7). For instance, the execution unit 112 may read the second matrices M2_1 to M2_4 from the temporary register 111 and then split the first matrix into a plurality of s*s subblocks. The execution unit 112 may collect the pixels at the same position in these second matrices M2_1 to M2_4 as the pixels of one of these s*s subblocks of the first matrix M1. For instance, the execution unit 112 may define row-column addresses (1, 1), (1, 2), (2, 1), and (2, 2) of the first matrix M1 as one subblock (herein referred to as a target subblock). The execution unit 112 may collect the four pixels LU, RU, LL, and RL of the same row-column address (1, 1) in these second matrices M2_1 to M2_4 as the upper left pixel LU, the upper right pixel RU, the lower left pixel LL, and the lower right pixel RL in the target subblock of the first matrix M1. Therefore, the execution unit 112 may knit the second matrices M2_1 to M2_4 into the first matrix M1. Similar to the description provided for FIG. 3 and FIG. 4, the temporary register 111 and the execution unit 112 may also knit the second matrices M4_1 to M4_9 shown in FIG. 8 into the first matrix M3 shown in FIG. 7.

According to different design needs, the matrix unknit-knit device 110, the execution unit 112, and/or the convolution operation device 130 may be implemented in a form of hardware, firmware, software (i.e., programs), or a combination of a plurality of the foregoing three. In the form of hardware, the matrix unknit-knit device 110, the execution unit 112, and/or the convolution operation device 130 may be implemented in the form of a logic circuit on an integrated circuit. Related functions of the matrix unknit-knit device 110, the execution unit 112, and/or the convolution operation device 130 may be implemented as hardware through using hardware description languages (e.g., Verilog HDL or VHDL) or other suitable programming languages. For instance, the related functions of the matrix unknit-knit device 110, the execution unit 112, and/or the convolution operation device 130 may be implemented as one or a plurality of controllers, micro controllers, microprocessors, application-specific integrated circuits (ASICs), digital signal processors (DSPs), field programmable gate arrays (FPGAs) and/or various logic blocks, modules, and circuits in other processing units. In the form of software and/or firmware, the related functions of the matrix unknit-knit device 110, the execution unit 112, and/or the convolution operation device 130 may be implemented as programming codes. For instance, the matrix unknit-knit device 110, the execution unit 112, and/or the convolution operation device 130 may be implemented by using a general programming language (e.g., C, C++, or an assembly language) or other suitable programming languages. The programming codes may be recorded/stored in a “non-transitory computer readable medium”. In some embodiments, the non-transitory computer readable medium includes, for example, a tape, a disk, a card, a semiconductor memory, a programmable logic circuit, and/or a storage device. The storage device includes a hard disk drive (HDD) a solid-state drive (SSD), or other storage devices. A central processing unit (CPU), a controller, a micro controller, or a micro processor may read and execute the programming code from the non-transitory computer readable medium to accomplish the related functions of the matrix unknit-knit device 110, the execution unit 112, and/or the convolution operation device 130.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

What is claimed is:

1. A convolution apparatus configured to perform a convolution operation with a stride greater than 1, the convolution apparatus comprising:
a data memory;
a matrix unknit-knit device coupled to the data memory and configured to unknit a first matrix stored in the data memory into s*s second matrices or knit the s*s second matrices stored in the data memory into the first matrix, wherein the s is an integer greater than 1 and is the stride of the convolution operation, the first matrix is split into a plurality of s*s subblocks, and s*s pixels in each of the plurality of s*s subblocks serve one-to-one as one pixel of the s*s second matrices; and
a convolution operation device coupled to the data memory, wherein the convolution operation device unknits a convolution kernel used for performing the convolution operation with a stride of s on the first matrix into s*s sub-kernels according to the s*s pixels, the s*s sub-kernels are applied one-to-one to the s*s second matrices, the convolution operation device uses any one of the s*s sub-kernels to perform a convolution operation with a stride of 1 on one corresponding second matrix among the s*s second matrices to generate a first operation result, and the convolution operation device accumulates the first operation result of each of the s*s second matrices as a second operation result of performing the convolution operation with the stride of s on the first matrix.

2. The convolution apparatus according to claim 1, wherein the matrix unknit-knit device reads the first matrix from the data memory, the matrix unknit-knit device splits the first matrix into the plurality of s*s subblocks, and the matrix unknit-knit device collects pixels at a same position in the plurality of s*s subblocks as pixels of one of the s*s second matrices to unknit the first matrix into the s*s second matrices.

3. The convolution apparatus according to claim 1, wherein the matrix unknit-knit device reads the s*s second matrices from the data memory, the matrix unknit-knit device splits the first matrix into the plurality of s*s subblocks, and the matrix unknit-knit device collects pixels at a same position in the s*s second matrices as pixels of one of the plurality of s*s subblocks of the first matrix to knit the s*s second matrices into the first matrix.

4. The convolution apparatus according to claim 1, wherein the stride s of the convolution operation is 2, the first matrix is split into a plurality of 2*2 subblocks, the 2*2 pixels in each of the plurality of 2*2 subblocks comprise an upper left pixel, an upper right pixel, a lower left pixel, and a lower right pixel, the 2*2 second matrices comprise a first unknitted matrix, a second unknitted matrix, a third unknitted matrix, and a fourth unknitted matrix, the upper left pixel of the plurality of 2*2 subblocks serve as a pixel of the first unknitted matrix, the upper right pixel of the plurality of 2*2 subblocks serve as a pixel of the second unknitted matrix, the lower left pixel of the plurality of 2*2 subblocks serve as a pixel of the third unknitted matrix, and the lower right pixel of the plurality of 2*2 subblocks serve as a pixel of the fourth unknitted matrix.

5. The convolution apparatus according to claim 1, wherein the stride s of the convolution operation is 3, the first matrix is split into a plurality of 3*3 subblocks, the 3*3 pixels in each of the plurality of 3*3 subblocks comprise an upper left pixel, upper middle pixel, upper right pixel, middle left pixel, middle middle pixel, middle right pixel, lower left pixel, lower middle pixel, and lower right pixel, the 3*3 second matrices comprise a first unknitted matrix, a second unknitted matrix, a third unknitted matrix, a fourth unknitted matrix, a fifth unknitted matrix, a sixth unknitted matrix, a seventh unknitted matrix, an eighth unknitted matrix, and a ninth unknitted matrix, the upper left pixel of the plurality of 3*3 subblocks serve as a pixel of the first unknitted matrix, the upper middle pixel of the plurality of 3*3 subblocks serve as a pixel of the second unknitted matrix, the upper right pixel of the plurality of 3*3 subblocks serve as a pixel of the third unknitted matrix, the middle left pixel of the plurality of 3*3 subblocks serve as a pixel of the fourth unknitted matrix, the middle middle pixel of the plurality of 3*3 subblocks serve as a pixel of the fifth unknitted matrix, the middle right pixel of the plurality of 3*3 subblocks serve as a pixel of the sixth unknitted matrix, the lower left pixel of the plurality of 3*3 subblocks serve as a pixel of the seventh unknitted matrix, the lower middle pixel of the plurality of 3*3 subblocks serve as a pixel of the eighth unknitted matrix, and the lower right pixel of the plurality of 3*3 subblocks serve as a pixel of the ninth unknitted matrix.

6. The convolution apparatus according to claim 1, wherein the stride s of the convolution operation is 2, the convolution kernel is a 3*3 matrix, the convolution kernel is unknitted into a first sub-kernel, a second sub-kernel, a third sub-kernel, and a fourth sub-kernel, the first sub-kernel is a 2*2 matrix and comprises an upper left pixel, an upper right pixel, a lower left pixel, and a lower right pixel of the convolution kernel, the second sub-kernel is a 2*1 matrix and comprises an upper middle pixel and a lower middle pixel of the convolution kernel, the third sub-kernel is a 1*2 matrix and comprises a middle left pixel and a middle right pixel of the convolution kernel, and the fourth sub-kernel is a 1*1 matrix and comprises a middle middle pixel of the convolution kernel.

7. The convolution apparatus according to claim 1, wherein the matrix unknit-knit device comprises:
a temporary register configured to read the first matrix or the s*s second matrices from the data memory; and
an execution unit coupled to the temporary register and configured to unknit the first matrix stored in the temporary register into the s*s second matrices or knit the s*s second matrices stored in the temporary register into the first matrix.

8. A convolution method configured to perform a convolution operation with a stride greater than 1, the convolution method comprising:
unknitting a first matrix stored in a data memory into s*s second matrices or knitting the s*s second matrices stored in the data memory into the first matrix by a matrix unknit-knit device, wherein the s is an integer greater than 1 and is the stride of the convolution operation, the first matrix is split into a plurality of s*s subblocks, and s*s pixels in each of the plurality of s*s subblocks serve one-to-one as one pixel of the s*s second matrices;
unknitting a convolution kernel used for performing the convolution operation with a stride of s on the first matrix into s*s sub-kernels according to the s*s pixels by a convolution operation device, wherein the s*s sub-kernels are applied one-to-one to the s*s second matrices;
using any one of the s*s sub-kernels to perform a convolution operation with a stride of 1 on one corresponding second matrix among the s*s second matrices to generate a first operation result by the convolution operation device; and
accumulating the first operation result of each of the s*s second matrices as a second operation result of performing the convolution operation with a stride of s on the first matrix by the convolution operation device.

9. The convolution method according to claim 8, further comprising:
reading the first matrix from the data memory by the matrix unknit-knit device;
splitting the first matrix into the plurality of s*s subblocks by the matrix unknit-knit device; and
collecting pixels at a same position in the plurality of s*s subblocks as pixels of one of the s*s second matrices to unknit the first matrix into the s*s second matrices by the matrix unknit-knit device.

10. The convolution method according to claim 8, further comprising:
reading the s*s second matrices from the data memory by the matrix unknit-knit device;
splitting the first matrix into the plurality of s*s subblocks by the matrix unknit-knit device; and
collecting pixels at a same position in the s*s second matrices as pixels of one of the plurality of s*s subblocks of the first matrix to knit the s*s second matrices into the first matrix by the matrix unknit-knit device.

11. The convolution method according to claim 8, wherein the stride s of the convolution operation is 2, the first matrix is split into a plurality of 2*2 subblocks, the 2*2 pixels in each of the plurality of 2*2 subblocks comprise an upper left pixel, an upper right pixel, a lower left pixel, and a lower right pixel, the 2*2 second matrices comprise a first unknitted matrix, a second unknitted matrix, a third unknitted matrix, and a fourth unknitted matrix, the upper left pixel of the plurality of 2*2 subblocks serve as a pixel of the first unknitted matrix, the upper right pixel of the plurality of 2*2 subblocks serve as a pixel of the second unknitted matrix, the lower left pixel of the plurality of 2*2 subblocks serve as a pixel of the third unknitted matrix, and the lower right pixel of the plurality of 2*2 subblocks serve as a pixel of the fourth unknitted matrix.

12. The convolution method according to claim 8, wherein the stride s of the convolution operation is 3, the first matrix is split into a plurality of 3*3 subblocks, the 3*3 pixels in each of the plurality of 3*3 subblocks comprise an upper left pixel, upper middle pixel, upper right pixel, middle left pixel, middle middle pixel, middle right pixel, lower left pixel, lower middle pixel, and lower right pixel, the 3*3 second matrices comprise a first unknitted matrix, a second unknitted matrix, a third unknitted matrix, a fourth unknitted matrix, a fifth unknitted matrix, a sixth unknitted matrix, a seventh unknitted matrix, an eighth unknitted matrix, and a ninth unknitted matrix, the upper left pixel of the plurality of 3*3 subblocks serve as a pixel of the first unknitted matrix, the upper middle pixel of the plurality of 3*3 subblocks serve as a pixel of the second unknitted matrix, the upper right pixel of the plurality of 3*3 subblocks serve as a pixel of the third unknitted matrix, the middle left pixel of the plurality of 3*3 subblocks serve as a pixel of the fourth unknitted matrix, the middle middle pixel of the plurality of 3*3 subblocks serve as a pixel of the fifth unknitted matrix, the middle right pixel of the plurality of 3*3 subblocks serve as a pixel of the sixth unknitted matrix, the lower left pixel of the plurality of 3*3 subblocks serve as a pixel of the seventh unknitted matrix, the lower middle pixel of the plurality of 3*3 subblocks serve as a pixel of the eighth unknitted matrix, and the lower right pixel of the plurality of 3*3 subblocks serve as a pixel of the ninth unknitted matrix.

13. The convolution method according to claim 8, wherein the stride s of the convolution operation is 2, the convolution kernel is a 3*3 matrix, the convolution kernel is unknitted into a first sub-kernel, a second sub-kernel, a third sub-kernel, and a fourth sub-kernel, the first sub-kernel is a 2*2 matrix and comprises an upper left pixel, an upper right pixel, a lower left pixel, and a lower right pixel of the convolution kernel, the second sub-kernel is a 2*1 matrix and comprises an upper middle pixel and a lower middle pixel of the convolution kernel, the third sub-kernel is a 1*2 matrix and comprises a middle left pixel and a middle right pixel of the convolution kernel, and the fourth sub-kernel is a 1*1 matrix and comprises a middle middle pixel of the convolution kernel.

14. The convolution method according to claim 8, further comprising:
reading the first matrix or the s*s second matrices from the data memory by a temporary register; and
unknitting the first matrix stored in the temporary register into the s*s second matrices or knitting the s*s second matrices stored in the temporary register into the first matrix by an execution unit.

15. A matrix unknit-knit device configured to perform a convolution operation with a stride greater than 1, wherein the matrix unknit-knit device comprises:
a temporary register configured to read a first matrix or s*s second matrices from a data memory; and
an execution unit coupled to the temporary register and configured to unknit the first matrix stored in the temporary register into the s*s second matrices or knit the s*s second matrices stored in the temporary register into the first matrix, wherein the s is an integer greater than 1 and is the stride of the convolution operation, the first matrix is split into a plurality of s*s subblocks, and s*s pixels in each of the plurality of s*s subblocks serve one-to-one as one pixel of the s*s second matrices.

16. The matrix unknit-knit device according to claim 15, wherein the execution unit reads the first matrix from the temporary register, the execution unit splits the first matrix into the plurality of s*s subblocks, and the execution unit collects pixels at a same position in the plurality of s*s subblocks as pixels of one of the s*s second matrices to unknit the first matrix into the s*s second matrices.

17. The matrix unknit-knit device according to claim 15, wherein the execution unit reads the s*s second matrices from the temporary register, the execution unit splits the first matrix into the plurality of s*s subblocks, and the execution unit collects pixels at a same position in the s*s second matrices as pixels of one of the plurality of s*s subblocks of the first matrix to knit the s*s second matrices into the first matrix.

18. The matrix unknit-knit device according to claim 15, wherein the stride s is 2, the first matrix is split into a plurality of 2*2 subblocks, the 2*2 pixels in each of the plurality of 2*2 subblocks comprise an upper left pixel, an upper right pixel, a lower left pixel, and a lower right pixel, the 2*2 second matrices comprise a first unknitted matrix, a second unknitted matrix, a third unknitted matrix, and a fourth unknitted matrix, the upper left pixel of the plurality of 2*2 subblocks serve as a pixel of the first unknitted matrix, the upper right pixel of the plurality of 2*2 subblocks serve as a pixel of the second unknitted matrix, the lower left pixel of the plurality of 2*2 subblocks serve as a pixel of the third unknitted matrix, and the lower right pixel of the plurality of 2*2 subblocks serve as a pixel of the fourth unknitted matrix.

19. The matrix unknit-knit device according to claim 15, wherein the stride s is 3, the first matrix is split into a plurality of 3*3 subblocks, the 3*3 pixels in each of the plurality of 3*3 subblocks comprise an upper left pixel, upper middle pixel, upper right pixel, middle left pixel, middle middle pixel, middle right pixel, lower left pixel, lower middle pixel, and lower right pixel, the 3*3 second matrices comprise a first unknitted matrix, a second unknitted matrix, a third unknitted matrix, a fourth unknitted matrix, a fifth unknitted matrix, a sixth unknitted matrix, a seventh unknitted matrix, an eighth unknitted matrix, and a ninth unknitted matrix, the upper left pixel of the plurality of 3*3 subblocks serve as a pixel of the first unknitted matrix, the upper middle pixel of the plurality of 3*3 subblocks serve as a pixel of the second unknitted matrix, the upper right pixel of the plurality of 3*3 subblocks serve as a pixel of the third unknitted matrix, the middle left pixel of the plurality of 3*3 subblocks serve as a pixel of the fourth unknitted matrix, the middle middle pixel of the plurality of 3*3 subblocks serve as a pixel of the fifth unknitted matrix, the middle right pixel of the plurality of 3*3 subblocks serve as a pixel of the sixth unknitted matrix, the lower left pixel of the plurality of 3*3 subblocks serve as a pixel of the seventh unknitted matrix, the lower middle pixel of the plurality of 3*3 subblocks serve as a pixel of the eighth unknitted matrix, and the lower right pixel of the plurality of 3*3 subblocks serve as a pixel of the ninth unknitted matrix.

20. A matrix unknit-knit method configured to perform a convolution operation with a stride greater than 1, wherein the matrix unknit-knit method comprises:
reading a first matrix or s*s second matrices from a data memory by a temporary register; and
unknitting the first matrix stored in the temporary register into the s*s second matrices or knitting the s*s second matrices stored in the temporary register into the first matrix by an execution unit, wherein the s is an integer greater than 1 and is the stride of the convolution operation, the first matrix is split into a plurality of s*s subblocks, and s*s pixels in each of the plurality of s*s subblocks serve one-to-one as one pixel of the s*s second matrices.

21. The matrix unknit-knit method according to claim 20, further comprising:
reading the first matrix from the temporary register by the execution unit;
splitting the first matrix into the plurality of s*s subblocks by the execution unit; and
collecting pixels at a same position in the plurality of s*s subblocks as pixels of one of the s*s second matrices to unknit the first matrix into the s*s second matrices by the execution unit.

22. The matrix unknit-knit method according to claim 20, further comprising:
reading the s*s second matrices from the temporary register by the execution unit;
splitting the first matrix into the plurality of s*s subblocks by the execution unit; and
collecting pixels at a same position in the s*s second matrices as pixels of one of the plurality of s*s subblocks of the first matrix to knit the s*s second matrices into the first matrix by the execution unit.

23. The matrix unknit-knit method according to claim 20, wherein the stride s is 2, the first matrix is split into a plurality of 2*2 subblocks, the 2*2 pixels in each of the plurality of 2*2 subblocks comprise an upper left pixel, an upper right pixel, a lower left pixel, and a lower right pixel, the 2*2 second matrices comprise a first unknitted matrix, a second unknitted matrix, a third unknitted matrix, and a fourth unknitted matrix, the upper left pixel of the plurality of 2*2 subblocks serve as a pixel of the first unknitted matrix, the upper right pixel of the plurality of 2*2 subblocks serve as a pixel of the second unknitted matrix, the lower left pixel of the plurality of 2*2 subblocks serve as a pixel of the third unknitted matrix, and the lower right pixel of the plurality of 2*2 subblocks serve as a pixel of the fourth unknitted matrix.

24. The matrix unknit-knit method according to claim 20, wherein the stride s is 3, the first matrix is split into a plurality of 3*3 subblocks, the 3*3 pixels in each of the plurality of 3*3 subblocks comprise an upper left pixel, upper middle pixel, upper right pixel, middle left pixel, middle middle pixel, middle right pixel, lower left pixel, lower middle pixel, and lower right pixel, the 3*3 second matrices comprise a first unknitted matrix, a second unknitted matrix, a third unknitted matrix, a fourth unknitted matrix, a fifth unknitted matrix, a sixth unknitted matrix, a seventh unknitted matrix, an eighth unknitted matrix, and a ninth unknitted matrix, the upper left pixel of the plurality of 3*3 subblocks serve as a pixel of the first unknitted matrix, the upper middle pixel of the plurality of 3*3 subblocks serve as a pixel of the second unknitted matrix, the upper right pixel of the plurality of 3*3 subblocks serve as a pixel of the third unknitted matrix, the middle left pixel of the plurality of 3*3 subblocks serve as a pixel of the fourth unknitted matrix, the middle middle pixel of the plurality of 3*3 subblocks serve as a pixel of the fifth unknitted matrix, the middle right pixel of the plurality of 3*3 subblocks serve as a pixel of the sixth unknitted matrix, the lower left pixel of the plurality of 3*3 subblocks serve as a pixel of the seventh unknitted matrix, the lower middle pixel of the plurality of 3*3 subblocks serve as a pixel of the eighth unknitted matrix, and the lower right pixel of the plurality of 3*3 subblocks serve as a pixel of the ninth unknitted matrix.
